(19) United States
(12) Patent Application Publication
(10) Pub. No.: US 2021/0117496 A1
(43) Pub. Date: Apr. 22, 2021

(54) METHOD AND SYSTEM FOR PROCESSING A SEARCH RESULT OF A SEARCH ENGINE SYSTEM

(71) Applicant: Visably, LLC, Jackson, WY (US)

(72) Inventors: Christopher Dickey, Jackson, WY (US); Frederick H Seymour, Jackson, WY (US)

(73) Assignee: Visably, LLC, Jackson, WY (US)

(21) Appl. No.: 16/655,468

(22) Filed: Oct. 17, 2019

Related U.S. Application Data
(60) Provisional application No. 62/915,735, filed on Oct. 16, 2019.

(51) Int. Cl. G06F 16/9538; G06F 16/955; G06K 9/62; G06N 20/00

(52) U.S. Cl. CPC G06F 16/9538; G06N 20/00; G06K 9/6267; G06F 16/955

(57) ABSTRACT

Disclosed herein is a method comprising receiving a reference to a resource from a search engine system, as a result of a search performed by the search engine system; retrieving the resource identified by the reference; determining frequencies of occurrence of a plurality of feature words in the resource; and classifying the reference into a class based on the frequencies of occurrence.

### BACKGROUND

Search engine systems play a central role in information gathering from the Internet. Examples of search engine systems include Google Search, Baidu, Yahoo! Search, Bing, DuckDuckGo, and many more. A user typically provides a search engine system with a description of the information the user seeks, using a suitable form of presentation such as words, images, and even sounds. The search engine system conducts a search based on the description and returns a result. The result often includes a collection of references to resources that are likely relevant to the information the user seeks.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method including: receiving a reference to a resource from a search engine system, as a result of a search performed by the search engine system, retrieving the resource identified by the reference, determining frequencies of occurrence of a plurality of feature words in the resource, and classifying the reference into a class based on the frequencies of occurrence. Other embodiments of this aspect include corresponding computer systems, apparatus, and computer programs recorded on one or more computer storage devices, each configured to perform the actions of the methods.

In an aspect, the reference is a Uniform Resource Identifier (URI).

In an aspect, the resource is a document in a markup language.

In an aspect, the resource is a text file.

In an aspect, at least one of the feature words is a set of synonyms.

In an aspect, at least one of the feature words is a set of words sharing a word stem.

In an aspect, the class is selected from the group consisting of paid search results, earned search results, e-commerce search results, and brand-owned search results.

In an aspect, classifying the reference comprises using a random forest machine learning algorithm.

In an aspect, classifying the reference comprises using a neural network machine learning algorithm.

In an aspect, classifying the reference comprises using a Bayesian machine learning algorithm.

In an aspect, the method further includes determining whether the resource includes one or more predetermined keywords.

In an aspect, determining whether the resource includes the one or more predetermined keywords is based on contents of the resource.

In an aspect, determining whether the resource includes the one or more predetermined keywords is based on metadata in the result.

In an aspect, the resource includes one or more predetermined keywords and the method further includes causing rendering of the result on a screen in a human-perceivable form, where a portion of the rendering representing the resource has a visual appearance distinct from that of another portion of the rendering representing another resource not including the one or more predetermined keywords.

In an aspect, the method further includes determining a fraction of references that are in the class and point to resources including one or more predetermined keywords among all references in the class.

In an aspect, the method further includes computing a score representing prevalence of one or more predetermined keywords in resources represented in the result.

A computer program product including a non-transitory computer readable medium having instructions recorded thereon, the instructions when executed by a computer implementing the method. Some implementations of the described techniques include hardware, a method or process, or computer software on a non-transitory computer-readable medium.

### BRIEF DESCRIPTION OF FIGURES

FIG. 1 schematically shows a result of a search performed by a search engine system.

FIG. 2 schematically shows that, when a reference in the result is received from the search engine system by a server, the server retrieves the resource that the reference points to.

FIG. 3 schematically shows that the server determines the frequencies of occurrence of a plurality of feature words in the resource and classifies the resource based on the frequencies of occurrence.

FIG. 4 schematically shows that a classifier used in the process of FIG. 3 is trained using a training data set, in an example.

FIG. 5 schematically shows an example of classified references in the result.

FIG. 6 schematically shows an example where a portion of the rendering representing the resources including a predetermined keyword has a visual appearance distinct from that of another portion of the rendering representing other resources not including the predetermined keyword.

FIG. 7 schematically shows examples of a fraction of the references that are in a given class and include a predetermined keyword among all the references in that class.

### DETAILED DESCRIPTION

Although a search engine system sometimes classifies the references in the result, the classification may not suit the needs of every user or may exclude information that is not explicitly provided to the search engine system. In an example where the description includes running shoes, the result may include advertising, a list of websites selling running shoes, a map or a list of brick-and-mortar stores that sell running shoes in the vicinity of the user, and a list of “organic” references pointing to online resources relevant to running shoes. The result in this example can be useful to a consumer looking for running shoes to purchase but may not be so to a marketer managing a running shoe brand who wishes to understand the various marketing channels through which consumers may engage with the running shoe brand when using a search engine system. Marketers need to know how their brand is performing in search results that are non-branded but related to their products and services. Searching directly for the brand will result in predictable search results that are about the brand but are not necessarily representative of how a customer may search for product advice or recommendations. Marketers need to repeat the customer discovery process that often includes related but non-branded search terms, by identifying where their brand may exist or be absent in a search result across marketing channels that they do not directly control (e.g., e-commerce and earned media) as well as those they do control (e.g., brand-owned and paid media).

Disclosed herein are methods, and a computer program product embodying the methods, for classifying the references in the result of a search performed by the search engine system. In an example, the references are classified into four classes: paid references, earned references, e-commerce references, and brand-owned references. The class of “paid references” includes those references whose placement in the result is purchased. The presentation of a reference in the class of “paid references” is usually determined by the purchaser, at least to some extent. The class of “earned references” includes those references whose placement in the result is not purchased (often called “organic”) and included in the result by the search engine system based on the relevance of the resources they point to with the description. One example of a reference in the class of “earned references” is one pointing to an online journalism website. The class of “e-commerce references” includes those references whose placement in the result is not purchased and pointing to websites whose primary business activity is to electronically retail other companies' branded products or services. One example of a reference in the class of “e-commerce references” is one pointing to a website of a department store. The class of “brand-owned references” includes those references whose placement in the result is not purchased and pointing to websites whose primary business activity is to electronically market the website owners' branded products or services. One example of a reference in the class of “brand-owned references” is one pointing to a website of a name brand. In an example, other suitable classes are used. In an example, these classes are mutually exclusive (i.e., no reference in the result falls into more than one class). In an example, these classes are collectively exhaustive (i.e., each reference in the result must fall into at least one class).

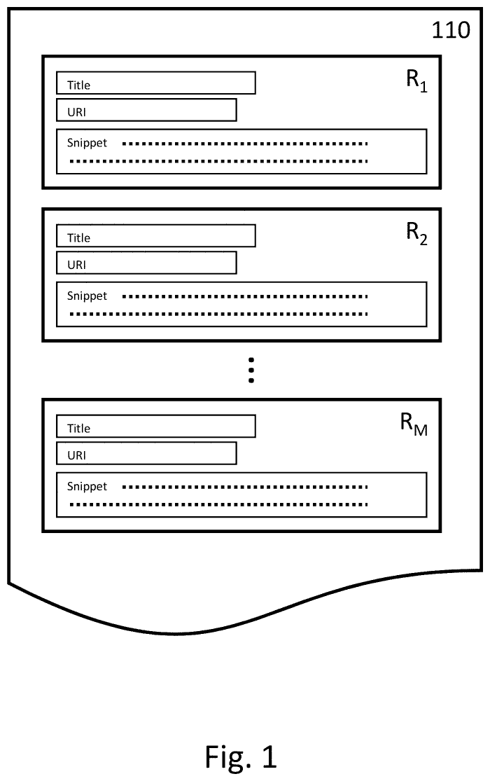

FIG. 1 schematically shows the result 110 of a search performed by the search engine system. The result 110 includes multiple references R₁, R₂, . . . , R_{M}. The references may be presented in any suitable way. In an example, each of the references includes a title, a Uniform Resource Identifier (URI), and a snippet of the resource pointed to. In an example, the presentation of the references is paginated. In an example, the resources pointed to by the references are located on one or more servers remote from the user. In an example, the resource is a text file. In an example, the resource is a document in a markup language (e.g., HTML, XHTML, XML).

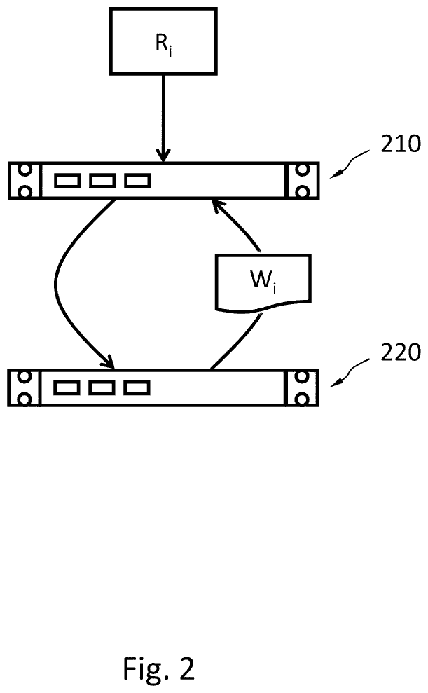

As schematically shown in FIG. 2, when a reference Rᵢ in the result 110 is received from the search engine system by a server 210, the server 210 retrieves the resource Wᵢ that the reference Rᵢ points to. For example, the server 210 sends a request to a remote server 220 hosting the resource Wᵢ and receives the resource Wᵢ from the remote server 220.

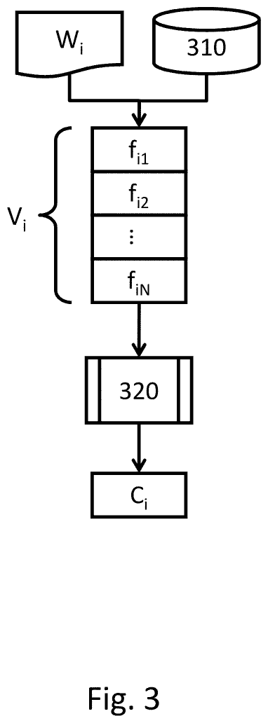

As schematically shown in FIG. 3, the server 210 determines the frequencies of occurrence of a plurality of feature words {F₁, F₂, . . . , F_{N}} in the resource Wᵢ. The feature words are members of a predetermined set 310 of words. In an example, the predetermined set of words is stored in a feature words library. In an example, the server 210 determines the frequency fᵢⱼ of occurrence of a feature word Fⱼ by counting the number Oᵢⱼ of occurrence of that feature word Fⱼ in the resource Wᵢ and dividing the number Oᵢⱼ of occurrence by the sum of the numbers of occurrence of all feature words in the resource Wᵢ, wherein j is an integer in the interval [1, N]. In other words, in this example, fᵢⱼ=Oᵢⱼ/ΣₖOᵢₖ. In an example, at least one of the feature words is a set of synonyms. For example, a feature word is the set {car, vehicle, automobile}. In an example, at least one of the feature words is a set of words sharing the word stem. For example, a feature word is the set {drive, drove, driven, drives, driving, driver, drivers}. In an example, the frequencies of occurrence of the feature words are organized as a feature vector Vᵢ for the reference Rᵢ pointing to the resource Wᵢ. The server 210 classifies the reference Rᵢ into a class Cᵢ based on the frequencies of occurrence, fᵢⱼ, j=1, 2, . . . , N, using a classifier 320.

In an example, the resource Wᵢ is preprocessed before the frequencies fᵢⱼ of occurrence are determined. For example, the encoding of the resource Wᵢ is converted (e.g., into ASCII), leading and trailing spaces are removed from the resource Wᵢ, non-numeric and non-alphabetic characters are removed from the resource Wᵢ, words too short (e.g., shorter than 3 characters) and too long (e.g., longer than 15 characters) are removed from the resource Wᵢ, synonyms in the resource Wᵢ are made the same word, or words sharing the same word stem in the resource Wᵢ are made the same word.

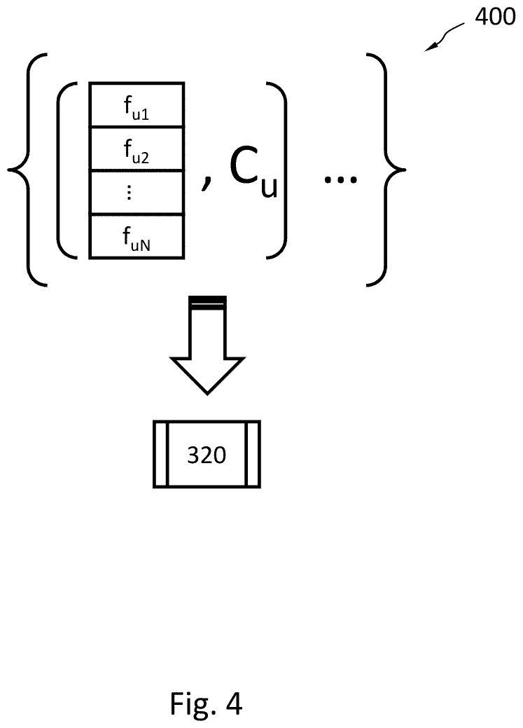

In an example, the classifier 320 uses a random forest machine learning algorithm but the classifier 320 is not limited to the random forest machine learning algorithm. As schematically shown in the example of FIG. 4, the classifier 320 is trained using a training data set 400. In an example, the training data set 400 includes frequencies {fᵤ₁, fᵤ₂, . . . , f_{uN}} of occurrence of the feature words {F₁, F₂, . . . , F_{N}} in multiple resources {Wᵤ, u=1, 2, . . . } and the classes {Cᵤ, u=1, 2, . . . } these resources belong to. The classes {Cᵤ} may be determined manually or using any other suitable method.

In an example, the classes {Cᵤ} are determined using a neural network machine learning algorithm. As used herein, the term “neural network machine learning algorithm” is an algorithm using a neural network (NN), also called artificial neural network (ANN). An NN can be implemented in a computing system where multiple nodes, also called artificial neurons, are connected. A node receives data from a first set of one or more nodes, processes the data and transmits the result to a second set of one or more nodes. By adjusting the connections among the nodes, the NN is “trained” for solving a problem (e.g., classification).

In an example, the classes {Cᵤ} are determined using a Bayesian machine learning algorithm. As used herein, the term “Bayesian machine learning algorithm” is an algorithm using Bayesian inference, which is a method of statistical inference in which Bayes' theorem is used to update the probability for a hypothesis as more evidence or information becomes available.

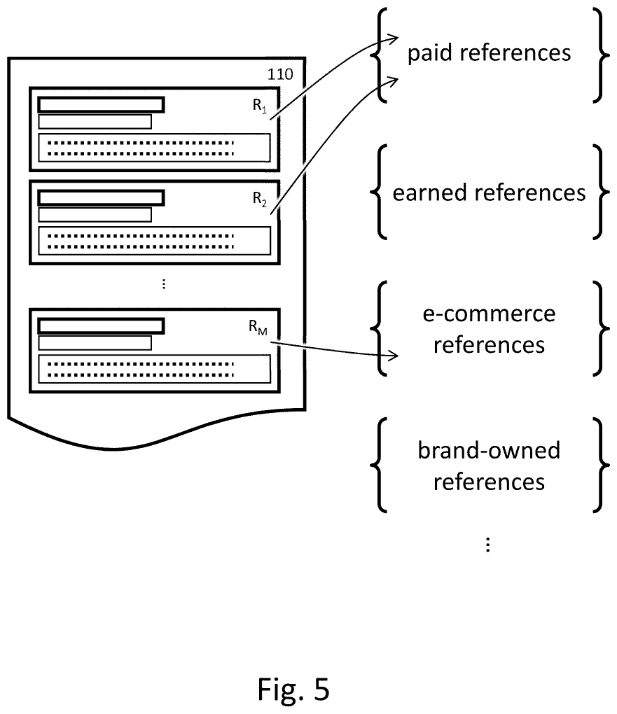

FIG. 5 schematically shows that the references {Rᵢ, i=1, 2, . . . , M} in the result 110 are classified into various classes using the system and method presented above. In this example, some of the references {Rᵢ} are put into the same class (e.g., R₁ and R₂ both put into the class “paid references”). In this example, none of the references {Rᵢ} is put into some (e.g., the class “brand-owned references”) of the classes.

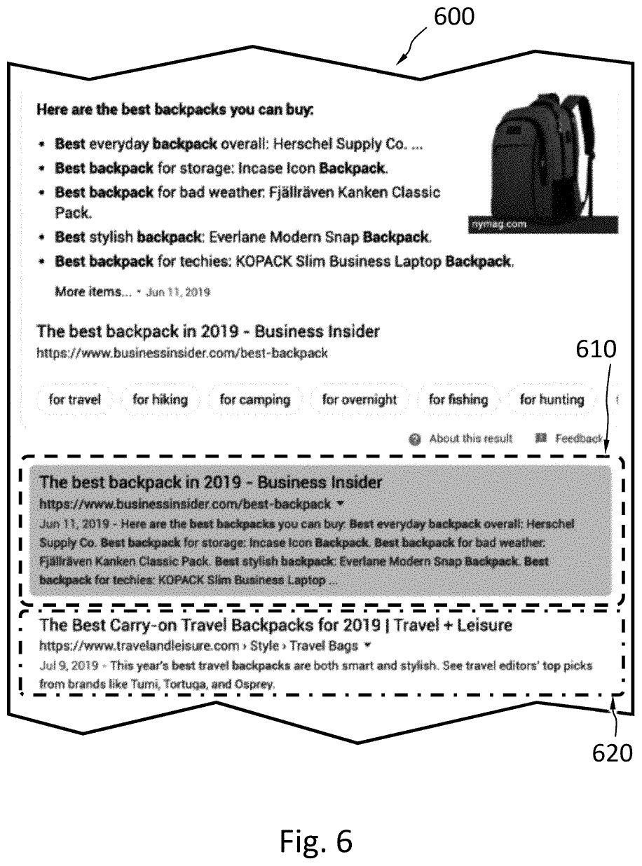

In an example, the server 210 determines whether the resources {Wᵢ} pointed to by the references {Rᵢ} in the result 110 include a predetermined keyword. In an example, this determination is based on the contents of the resources {Wᵢ}. In an example, this determination is based on metadata in the result 110. The metadata are information in the result 110 that are not part of any of the references {Rᵢ}. In an example, the predetermined keyword is a brand. In an example, the server 210 causes rendering of the result 110 on a screen in a human-perceivable form (e.g., texts, graphs, images, audios and videos). In an example, the screen is on a device remote to the server 210. As schematically shown in the example of FIG. 6, a portion 610 of the rendering 600 representing the resources including the predetermined keyword has a visual appearance distinct from that of another portion 620 of the rendering 600 representing other resources not including the predetermined keyword. For example, the portion 610 has a different background, size, font or color from that of the portion 620.

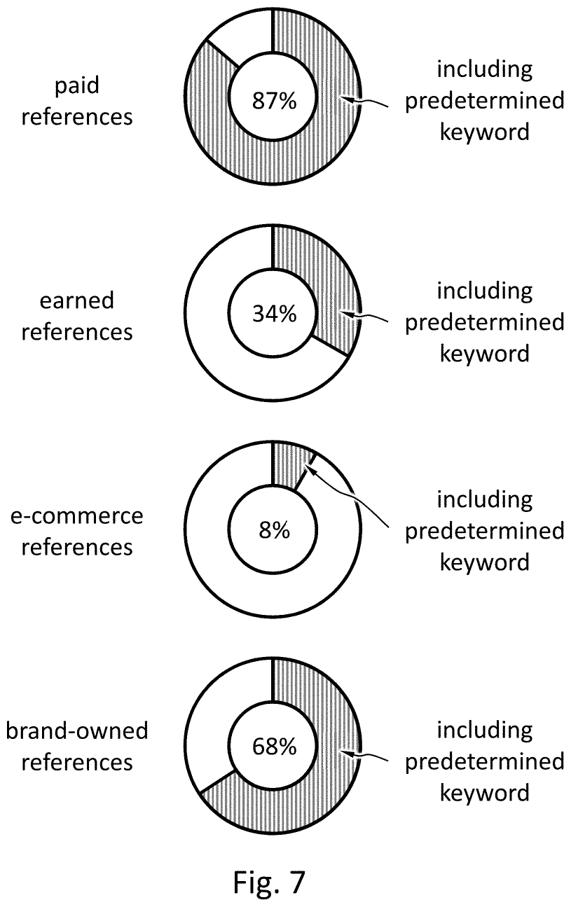

In an example, the server 210 determines a fraction of the references that are in a class and include a predetermined keyword among all the references in that class. As schematically shown in the example of FIG. 7, 87% of the references in the class “paid references” point to resources including the predetermined keyword, 34% of the references in the class “earned references” point to resources including the predetermined keyword, 8% of the references in the class “e-commerce references” point to resources including the predetermined keyword, and 68% of the references in the class “brand-owned references” point to resources including the predetermined keyword. In an example, the server 210 causes rendering of the fractions on a screen in a human-perceivable form (e.g., a donut chart).

In an example, the server 210 computes a score representing the prevalence of the predetermined keyword in resources represented in the result 110. In an example, the server 210 causes rendering of the fractions on a screen in a human-perceivable form.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method comprising:
receiving a reference to a resource from a search engine system, as a result of a search performed by the search engine system;
retrieving the resource identified by the reference;
determining frequencies of occurrence of a plurality of feature words in the resource; and
classifying the reference into a class based on the frequencies of occurrence.

2. The method of claim 1, wherein the reference is a Uniform Resource Identifier (URI).

3. The method of claim 2, wherein at least one of the feature words is a set of synonyms.

4. The method of claim 1, wherein the resource is a document in a markup language.

5. The method of claim 1, wherein the resource is a text file.

6. The method of claim 1, wherein at least one of the feature words is a set of synonyms.

7. The method of claim 1, wherein at least one of the feature words is a set of words sharing a word stem.

8. The method of claim 1, wherein the class is selected from the group consisting of paid search results, earned search results, e-commerce search results, and brand-owned search results.

9. The method of claim 1, wherein classifying the reference comprises using a random forest machine learning algorithm.

10. The method of claim 1, wherein classifying the reference comprises using a neural network machine learning algorithm.

11. The method of claim 1, wherein classifying the reference comprises using a Bayesian machine learning algorithm.

12. The method of claim 1, further comprising determining whether the resource includes one or more predetermined keywords.

13. The method of claim 12, wherein determining whether the resource includes the one or more predetermined keywords is based on contents of the resource.

14. The method of claim 12, wherein determining whether the resource includes the one or more predetermined keywords is based on metadata in the result.

15. The method of claim 1,
wherein the resource includes one or more predetermined keywords;
wherein the method further comprises causing rendering of the result on a screen in a human-perceivable form; and
wherein a portion of the rendering representing the resource has a visual appearance distinct from that of another portion of the rendering representing another resource not including the one or more predetermined keywords.

16. The method of claim 1, further comprising determining a fraction of references that are in the class and point to resources including one or more predetermined keywords among all references in the class.

17. The method of claim 1, further comprising computing a score representing prevalence of one or more predetermined keywords in resources represented in the result.

18. A computer program product comprising a non-transitory computer readable medium having instructions recorded thereon, the instructions when executed by a computer implementing the method of claim 1.
